(19) United States
(12) Patent Application Publication
(10) Pub. No.: US 2005/0027839 A1
(43) Pub. Date: Feb. 3, 2005

(54) Method, system and program product for dynamic transmission in a messaging session

(75) Inventors: Don Rutledge Day, Austin, TX (US); Robert J. Kamper, Round Rock, TX (US); Larry Don Swofford, Georgetown, TX (US)

Correspondence Address: DILLON & YUDELL LLP, 8911 NORTH CAPITAL OF TEXAS HIGHWAY, SUITE 2110, AUSTIN, TX, 78759, US

(73) Assignee: International Business Machiness Corporation

(21) Appl. No.: 10/631,058

(22) Filed: Jul. 31, 2003

(51) Int. Cl. G06F 15/173

(52) U.S. Cl. 709/223

(57) ABSTRACT

When the number of characters typed in an instant message window reaches a preset length parameter, the partially typed message is automatically sent to the message recipient with an ellipsis appended to the end of the partial message to inform the message recipient they have received only a portion of the message. While the partial message is transmitted, the message sender continues to type the message without interruption, and if the number of characters input into the message window since the last transmission reaches the preset length parameter, the latest partially typed message is automatically transmitted. The process repeats as the message sender continues to type the message, causing portions of the message to be automatically transmitted to the recipient during the composition process, until the sender selects send and the entire composed message, comprising a concatenation of all transmitted partial messages and any remaining typed characters, is sent to the recipient.

### CROSS REFERENCE TO RELATED APPLICATIONS

The present application is related to U.S. patent application Ser. No. ______ (AUS920030562US1) which is assigned to the assignee of the present invention and is incorporated herein by reference, in its entirety.

### TECHNICAL FIELD

This invention relates in general to management of messaging sessions, and more particularly relates to management of message transmission within a messaging session.

### BACKGROUND

Messaging using various desktop and mobile messaging-enabled digital devices over networks has become commonplace. Messaging methods are varied and include voice messaging and various forms of electronic messaging such as paging, email, fax, instant message exchange, short message services (“SMS”), voice over internet protocol, conference, and chat. Recently, instant message exchange has become very popular. A number of companies offer various solutions for instant message exchange over networks such as the Internet, including Yahoo! Inc., America Online, Inc., and Microsoft Corporation. Typically, these solutions facilitate the exchange of instant messages between the user of a client personal computer system and message recipients, which are commonly referred to by such terms as “pals,” “buddies,” “friends,” “contacts” or “strangers.” These message recipients may be people or machines such as servers. A message recipients may also be a group of people or robots. Instant messages are exchanged essentially instantaneously, or in “real time,” superseding the pace of many other messaging techniques.

Many of the well-known solutions for instant message exchange over the Internet are based on a client-server model. The clients are personal computers (“PCs”), personal digital assistants (“PDAs”), phones and browsers (including Microsoft® Internet Explorer and Netscape® Navigator). The applications running on these clients are implemented in a variety of software languages and with a variety of protocols, including the wireless access protocol (“WAP”), short message service (“SMS”), hypertext markup language (“HTML”), JavaScript, Java applets, Brew script, J2ME script, and C, C++, or XML code sections. Many instant message exchange solutions work in conjunction with a server based host application over the Internet network or wireless networks to carry out instant message exchange. The server component manages message traffic, delivery, and reporting, while the client component displays an instant message exchange window to show the received message. Alternatively, some solutions, especially those for advanced types of communications devices, do not require a server based instant messaging host application for communications once a connection is made, and may use peer-to-peer communications instead. These solutions typically are implemented with a pre-installed or downloaded client application on, for example, a personal computer, which manages message traffic, delivery, and reporting.

Various distribution techniques for the various solutions are also well known. Client applications, including applications that support peer-to-peer messaging as well as browser plug-ins, may be pre-installed or in firmware, or made available in software form from computer-readable media, such as software loaded from storage media, including magnetic storage media such as diskette, tape and fixed disk, semiconductor storage media such as various types of flash memory cards, and optical storage media such as CD-ROM and DVD-ROM, and software downloaded from distribution media such as networks, including wired and wireless networks, local and wide-area networks, and the Internet. Scripts and short code segments furnished to general purpose browsers typically are downloaded from a network.

A typical feature of the various instant message exchange solutions is keeping track of and visually indicating whether the user's authorized message recipients are online or offline. Instant messages may be sent to and received from any of the user's message recipients who are online. Other typical features include management of the various message recipients, including the grouping of individual message recipients, the addition and deletion of message recipients, and the setting of privacy options; multiparty real time chats with message recipients; and file exchange with message recipients. Some solutions alert the user when particular message recipients come online, provide for voice chat or even multiparty voice conference calls, offer instant message archiving, and permit sending instant messages to offline message recipients. Some solutions provide an electronic whiteboard which allows the user to draw images and type notes to share with others.

Unfortunately, while instant messaging and chat room interfaces offer the advantage of real-time text communication, these systems present significant limitations to effective communication. For example, computer-mediated text communications lack the dramaturgical presence such as voice tone, inflection, timing, and other visual non-verbal queues that permit people to adjust to and handle multiple interrupts and threads during communications. These communication difficulties are further exaggerated by delays in messages resulting from network failures, a synchronized call-and-response threads, participants exiting from a chat room, the time required to compose each new message, and other breaks in communications. What is needed is a method and system of managing messaging sessions that addresses some of the above problems to provide improved messaging session communication.

### SUMMARY OF THE INVENTION

In accordance with the present invention, a method, system and program product for dynamic transmission in a messaging session is provided. A data processing system for managing a messaging session performs the steps of receiving a plurality of characters from a message sender within the messaging session, wherein the plurality of characters forms a portion of a message within the messaging session; determining that the number of characters of the received plurality of characters is at least equal to a preset number of characters; determining that the end of the message is not contained within the plurality of characters; and transmitting the plurality of characters to a message recipient within the messaging session.

The present invention includes transmitting an indication that the transmitted plurality of characters forms only a portion of the message. The present invention further comprises the steps of concatenating another plurality of characters that forms a portion of the message to the transmitted plurality of characters, thereby creating concatenated characters; and transmitting the concatenated characters to the message recipient within the messaging session; and determining that the number of characters of the another plurality of characters is at least equal to a preset number of characters; and wherein the step of concatenating is performed once it is determined that the number of characters of the another plurality of characters is at least equal to the preset number of characters.

### BRIEF DESCRIPTION OF THE DRAWINGS

FIG. 1 shows a high-level block diagram of a data processing system consistent with an embodiment of the invention with which the method, system and program of the present invention may advantageously be utilized.

FIG. 2 depicts a simplified block diagram of a client/server environment in which electronic messaging typically takes place, in accordance with a preferred embodiment.

FIG. 3 shows an example of a user interface window within an instant messaging program that permits the user to enter preferences for display and transmission settings, in accordance with a preferred embodiment.

FIG. 4 shows a flow diagram of the process for dynamic messaging by the instant messaging program in a messaging session, in accordance with a preferred embodiment of the present invention.

FIG. 5 shows a screenshot of the message recipient's instant messaging window during a messaging session, in accordance with a preferred embodiment.

FIG. 6 shows a flow diagram of another preferred embodiment of dynamic flow of messaging in a messaging session, including a “switch to e-mail” (STE) option, in accordance with a preferred embodiment.

FIG. 7 shows a flow diagram of a process for initiating an e-mail from an instant messaging session, in accordance with a preferred embodiment of the present invention.

### DETAILED DESCRIPTION OF PREFERRED EMBODIMENTS

A preferred embodiment of the present invention is directed to software tools and associated methods of managing instant messaging executing within a data processing system to provide a dynamic flow of messages within the messaging session. These software tools and associated methods are embodied within a data processing system, the system software, or a user application such as an instant messenger or chat room application to provide the dynamic flow of messages.

In a preferred embodiment of the present invention, the number of characters input into a message window is counted as a message sender composes the message. When the number of characters typed in a message reaches a preset length parameter, the partial message that has been typed in the message window is automatically sent to the message recipient. An ellipsis is appended to the end of the partial message to inform the message recipient that the received text is only a partial message and that the remainder of the message will follow. The message sender continues to type the message without interruption, while the message recipient receives partial message, which is the first part of the message. The count is reset and the number of characters input into the message window is again counted as a message sender composes the message. When the number of characters typed in the message since the last transmission of the partial message reaches a preset length parameter, the latest portion of the message is automatically sent to the message recipient. The process repeats as the message sender continues to type the message, causing portions of the message to be automatically transmitted to the recipient during the composition process. When the sender concludes the message by selecting send or enter, the entire composed message, comprising a concatenation of all transmitted partial messages and any remaining typed characters, is sent to the recipient.

Hardware Overview

The present invention may be executed in a variety of systems, including a variety of computing systems and electronic devices under a number of different operating systems. In one embodiment of the present invention, the messaging system is a portable computing system such as a notebook computer, a palmtop computer, a personal digital assistant, a telephone or other electronic computing system that may also incorporate communications features that provide for telephony, enhanced telephony, messaging and information services. However, the messaging system may also be, for example, a desktop computer, a network computer, a midrange computer, a server system or a mainframe computer. Therefore, in general, the present invention is preferably executed in a computer system that performs computing tasks such as manipulating data in storage that is accessible to the computer system. In addition, the computer system preferably includes at least one output device and at least one input device.

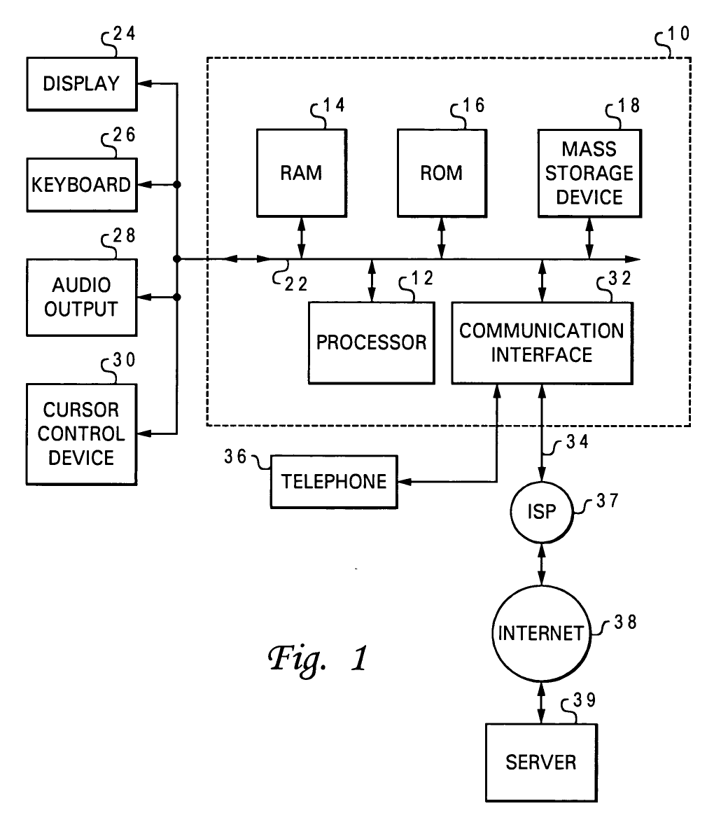

Referring now to the drawings, wherein like numbers denote like parts throughout the several views, FIG. 1 shows a high-level block diagram of a data processing system 10, which may be a high-level computer system, consistent with an embodiment of the invention with which the method, system and program of the present invention may advantageously be utilized. A computer system can be considered as three major components: (1) the application programs, such as a spreadsheet or word processing or graphics presentation application, which are used by the user; (2) the operating system that transparently manages the application's interactions with other applications and the computer hardware; and (3) the computer hardware comprising the processor, the random access memories, the actual electronic components which manage the digital bits. The operating system has a kernel which, inter alia, controls the execution of applications, processes, and/or objects by allowing their creation, termination or suspension, and communication; schedules processes/objects of the same or different applications on the hardware, allocates memory for those objects, administers free space, controls access and retrieves programs and data for the user.

Data processing system or computer system 10 comprises a bus 22 or other communication device for communicating information within computer system 10, and at least one processing device such as processor 12, coupled to bus 22 for processing information. While a single CPU is shown in FIG. 1, it should be understood that computer systems having multiple CPUs could be used. Bus 22 preferably includes low-latency and high-latency paths that are connected by bridges and controlled within computer system 10 by multiple bus controllers.

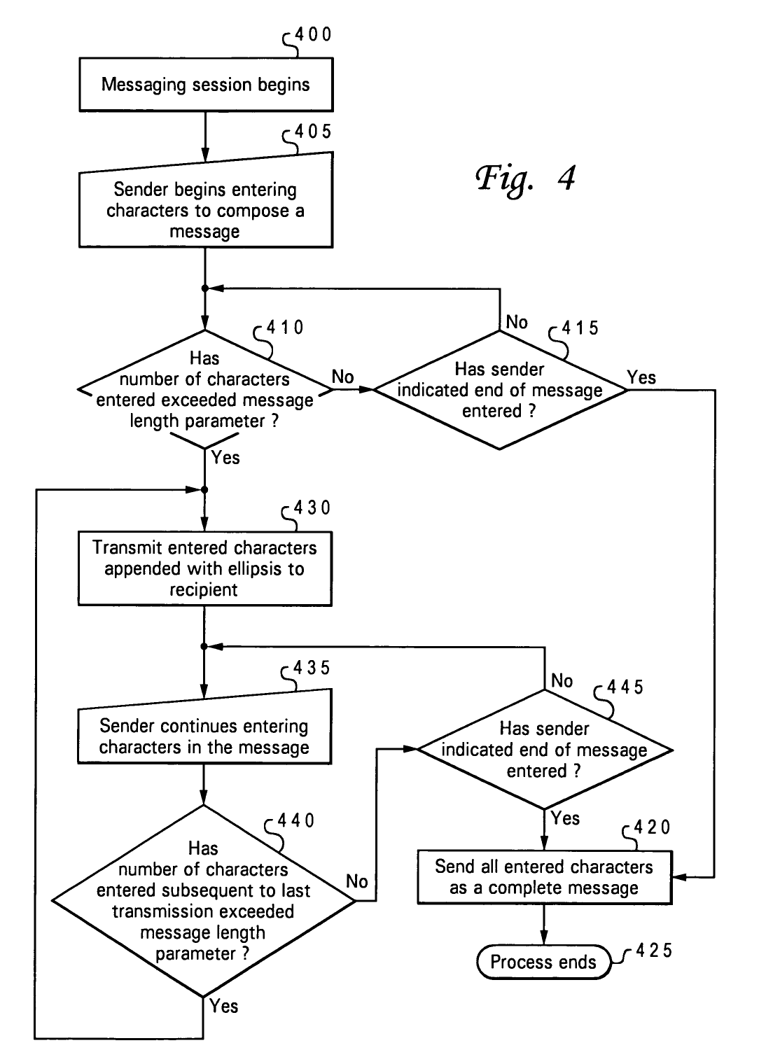

Processor 12 may be a general-purpose processor such as IBM's PowerPC.™ processor that, during normal operation, processes data under the control of operating system and application software stored in a dynamic storage device such as random access memory (RAM) 14 and a static storage device such as Read Only Memory (ROM) 16 and mass storage device 18, all for storing data and programs. The system memory components are shown conceptually as single monolithic entities, but it is well known that system memory is often arranged in a hierarchy of caches and other memory devices. The operating system preferably provides a graphical user interface (GUI) to the user. In a preferred embodiment, application software contains machine executable instructions that when executed on processor 12 carry out the operations depicted in the flowcharts of FIGS. 4, 6, 7, and others described herein. Alternatively, the steps of the present invention might be performed by specific hardware components that contain hardwire logic for performing the steps, or by any combination of programmed computer components and custom hardware components.

Communication bus 22 supports transfer of data, commands and other information between different devices within computer system 10; while shown in simplified form as a single bus, it may be structured as multiple buses, and may be arranged in a hierarchical form. Further, multiple peripheral components may be attached to computer system 10 via communication bus 22. For example, an audio output 28 is attached to bus 22 for controlling audio output through a speaker or other audio projection device. A display 24 such as a cathode-ray tube display, a flat panel display, or a touch panel is also attached to bus 22 for providing visual, tactile or other graphical representation formats. A keyboard 26 and cursor control device 30, such as a mouse, trackball, or cursor direction keys, are coupled to bus 22 as interfaces for user inputs to computer system 10. In alternate embodiments of the present invention, additional input and output peripheral components may be added. Communication bus 22 may connect a wide variety of other devices (not shown) to computer system 10 and to other adapters connected to other devices such as, but not limited to, audio and visual equipment, tape drives, optical drives, printers, disk controllers, other bus adapters, PCI adapters, workstations using one or more protocols including, but not limited to, Token Ring, Gigabyte Ethernet, Ethernet, Fibre Channel, SSA, Fiber Channel Arbitrated Loop (FCAL), Ultra3 SCSI, Infiniband, FDDI, ATM, ESCON, wireless relays, USB, Twinax, LAN connections, WAN connections, high performance graphics, etc., as is known in the art.

Communication interface 32 provides a physical interface to a network, such as the Internet 38. This interface may comprise a modem connected to a telephone line 34 through which an Internet access provider (ISP) 37 or online service provider is reached, but increasingly other higher bandwidth interfaces are implemented. For example, data processing or computer system 10 may be connected to another network server via a local area network using an Ethernet, Token Ring, or other protocol, the second network server in turn being connected to the Internet. Alternatively, communication interface 32 may be provided communication through cable television, fiber optics, satellites, wireless, or other connections. Communication interface 32 has capability to communicate with communications systems, such as integrated services digital network (ISDN), public telephone switched network (PTSN), or asynchronous digital subscriber line (ADSL), and with telecommunication systems such as telephone 36 independently coupled to the PTSN. Internet 38 may refer to the worldwide collection of networks and gateways that use a particular protocol, such as Transmission Control Protocol (TCP) and Internet Protocol (IP), to communicate with one another. ISP 37 and Internet 38 both use electrical, electromagnetic, or optical signals that carry digital data streams. The signals through the various networks and the signals on network link 34 and through communication interface 32, which carry the digital data to and from computer system 10, are exemplary forms of carrier waves transporting the information. The representation of FIG. 1 is intended as an exemplary simplified representation of a high-end computer system, it being understood that in other data processing systems 10, variations in system configuration are possible in addition to those mentioned here.

Finally, data processing system 10 need not be a computer at all. Data processing system 10 may be a simpler appliance-like client device, also called an embedded device, having less processing power and memory such as a network terminal, a thin client, a terminal-like device, a voice response unit, etc. Data processing system 10 may be a mobile architecture such as laptops, sub-notebooks, and handheld computers such as personal digital assistants and companion devices, or a mobile device such as smartphones, pagers, simple messaging devices and wearable devices. Thus, when the data processing system 10 is a mobile or an embedded device, a variety of multi-modal interfaces are supported including traditional keyboard and mouse interfaces, small text screens, pen, touch screens, speech recognition, text-to-speech and other emerging technologies like wearable devices. Such special-purpose devices for accessing the world wide web, such as an Internet access box for a television set, or a portable wireless web accessing device, which can implement an adapter for the purpose of communicating data to/from another computer system are also intended to be within the scope of a data processing system 10. As will be described in detail below, aspects of the preferred embodiment pertain to a specific method or process having steps implementable on a data processing system 10.

The present invention may be provided as a computer program product, included on a machine-readable medium having stored thereon the machine executable instructions used to program computer system 10 and/or to a peripheral device for installation on a connected adapter to perform a process according to the present invention. The term “machine-readable medium” as used herein includes any medium, signal-bearing media or computer readable storage media that participates in providing instructions to processor 12 or other components of computer system 10 for execution. Such a medium may take many forms including, but not limited to, non-volatile media, volatile media, and transmission media. Common forms of non-volatile media include, for example, a floppy disk, a flexible disk, a hard disk, magnetic tape or any other magnetic medium, a compact disc ROM (CD-ROM) or any other optical medium, punch cards or any other physical medium with patters of holes, a programmable ROM (PROM), an erasable PROM (EPROM), electrically EPROM (EEPROM), a flash memory, any other memory chip or cartridge, or any other medium from which computer system 10 can read and which is suitable for storing instructions. In the present embodiment, an example of nonvolatile media is storage device 18. Volatile media includes dynamic memory such as RAM 14. Transmission media includes coaxial cables, copper wire or fiber optics, including the wires that comprise bus 22. Transmission media can also take the form of electromagnetic, acoustic or light waves, such as those generated during radio wave or infrared wireless data communications. Thus, the programs defining the functions of the preferred embodiment can be delivered to the data processing system 10 information on any machine-readable medium, which include, but are not limited to: (a) information permanently stored on non-write storage media, e.g., read only memory devices within either computer such as CD-ROM disks readable by CD-ROM; (b) alterable information stored on write-able storage media, e.g., floppy disks within a diskette drive or a hard-disk drive; or (c) information conveyed to a computer by a telephone or a cable media network, including wireless communications. Such signal-bearing media, when carrying instructions that may be read by an adapter or a computer to direct the functions of the present invention, represent alternative embodiments.

Messaging Systems Context

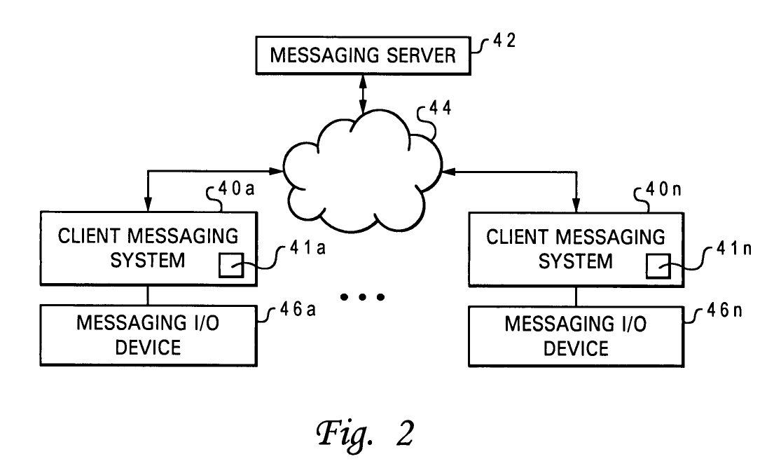

With reference now to FIG. 2, there is depicted a simplified block diagram of a client/server environment in which electronic messaging typically takes place in accordance with the method, system and program of the present invention. In a preferred embodiment, a client enters a message via one of messaging input/output (I/O) devices 46a-46n for a messaging session at a client messaging system such as client messaging system 40a. The message entry is transmitted to messaging server 42. Messaging server 42 then distributes the message entry to the users participating in the messaging session via network 44. The client/server environment is implemented within multiple network architectures. For example, the architecture of the World Wide Web (the Web) follows a traditional client/server modeled environment.

The terms “client” and “server” are used to refer to a computer's general role as a requester of data (the client) or provider of data (the server). Further, the terms “sender” and “recipient” are used to refer to a computer's general role as a sender of a messege during a messaging session (the message sender) or as a receiver of a messege during a messaging session (the recipient). In the Web environment, web browsers such as Netscape Navigator typically reside on client messaging systems 40a-40n and render Web documents (pages) served by at least one messaging server such as messaging server 42. Additionally, each of client messaging systems 40a-40n and messaging server 42 may function as both a “client” and a “server” and may be implemented utilizing a computer system such as computer system 10 of FIG. 1. Further, each of client messaging systems 40a-40n may function as both a “sender” and a “recipient” and typically act as both during a typical messaging session. Still further, while the present invention is described with emphasis upon client messaging systems 40a-40n engaged in peer-to-peer network communications via a network 44, the present invention may also be performed by messaging server 42 controlling a messaging session. Furthermore, other types of messaging systems may be utilized to implement the present invention, as will be understood by one skilled in the art.

The Web may refer to the total set of interlinked hypertext documents residing on servers all around the world. Network 44, such as the Internet, provides an infrastructure for transmitting these hypertext documents between client messaging systems 40a-40n and messaging server 42. Documents (pages) on the Web may be written in multiple languages, such as Hypertext Markup Language (HTML) or Extensible Markup Language (XML), and identified by Uniform Resource Indicators (URIs) that specify the particular messaging server 42 and pathname by which a file can be accessed, and then transmitted from messaging server 42 to an end user utilizing a protocol such as Hypertext Transfer Protocol (HTTP). Web pages may further include text, graphic images, movie files, and sounds as well as Java applets and other small-embedded software programs that execute when the user activates them by clicking on a link.

Advantageously, according to one embodiment of the present invention, the steps of the present invention and other functions may be performed by an application executing in each of client messaging systems 40a-40n, such as client managing applications 41a-41n. Further, client messaging systems 40a-40n may include or receive information from client messaging systems 40a-40n, communication devices, personal storage devices, global positioning systems, and other devices that provide personal information about a user that client managing applications 41a-41n may provide to messaging server 42. For example, where personal exercise information is received, client managing applications 41a-41n may determine that a user is exercising while communicating via one of client messaging systems 40a-40n. Further, advantageously, a client messaging system may access more than one messaging server 42 at the same time where each messaging server 42 represents an independent messaging system with independent user interfaces and protocols.

Messaging System Processes

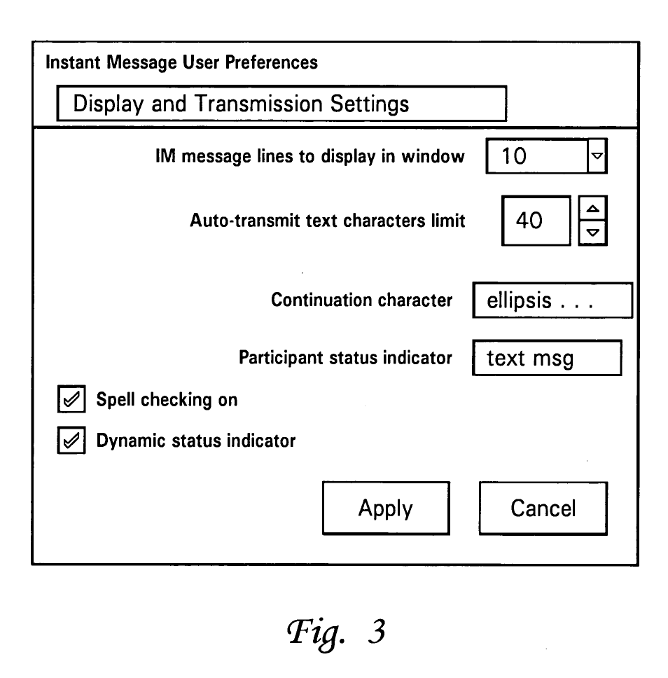

FIG. 3 shows an example of a user interface window within an instant messaging program that permits the user to enter preferences for display and transmission settings, in accordance with the preferred embodiment. FIG. 4 shows a flow diagram of the process for dynamic messaging by the instant messaging program in a messaging session, in accordance with the preferred embodiment of the present invention. The process begins when a messaging session is initiated by an instant messaging application, as shown at step 400. At step 405, the sender begins typing a message into a message window to compose the instant message. At step 410, a determination is made whether the number of characters typed by the sender in the message box has exceeded a message length parameter set by the “Auto-transmit text characters limit” user preference within the instant messaging program. As seen in FIG. 3, the “auto-transmit text characters limit” setting allows the user to set the number of characters for the message length parameter that triggers the automatic transmission of the sender's text. In the example of FIG. 3, the user has set the character limit to “40” characters.

While the preferred embodiment sets the message length parameter based on the number of characters typed in an instant message, it should be understood that the present invention is equally applicable to other forms of communication and that the message length parameter would be set based on the number of units of data that are quantified by the communications application. For example, in the present embodiment, the message length parameter is set based on the number of typewritten characters. In alternative embodiments, the messaging session could be conducted with graphics, audio, video, or other message types within the messaging session. In these cases, the message length parameter is set to the applicable unit for the data type being input into a messaging window and being transmitted during the messaging session (for example, video data could be measured in megabytes).

Returning to FIG. 4, the process proceeds to step 410 to determine if the number of characters entered in the messaging window has exceeded the message length parameter set by the user. If not, the process proceeds to step 415 to determine whether the sender has hit a send or enter character to indicate that the sender has completed the composition of the message and is requesting transmission of the message. If so, the process proceeds to step 420 where the completed message is sent to the message recipient, and thereafter the process ends as shown at step 425. If the decision at step 415 is that the sender has not indicated that the end of the message has been reached, the process returns to step 410 to determine if the number of characters entered in the messaging window has exceeded the message length parameter set by the user.

If the decision at step 410 is that the number of characters entered in the messaging window has exceeded the message length parameter set by the user, the process proceeds to step 430 where the characters entered in the sender's messaging window up to that point are automatically transmitted to the message recipient. Also at step 430, in a preferred embodiment, a continuation character is appended to the end of the entered characters and the entered characters appended with the continuation character are transmitted to the message recipient for display within the message recipient's instant messaging window. The continuation character is displayed as an ellipsis or some other predetermined character to indicate that the received message is only a partial message and that the message sender is still in the process of composing the entire message.

FIG. 3 shows that a preferred continuation character is set by the user (in this example being set as an ellipsis). In a preferred embodiment, the continuation character preference is set by the message sender and specifies the type of continuation character sent with the partial message to the recipient. In an alternative embodiment, the continuation character preference is set by the message recipient, and the continuation character appended to the partial message is a universal continuation code interpreted by the recipient's instant messaging application to indicate that the message being sent is a partial message. The recipient's application then handles the partial message as directed by the recipient in the instant message user preferences. In alternative embodiments, the continuation character that is appended to the end of the automatic transmission could be displayed as a graphic image displayed on the recipient's message window such as an icon or avatar. For example, a keyboard icon or animated gif could be displayed at the end of the text message. In alternative embodiments, the continuation character that is appended to the end of the automatic transmission could be a separate file or executable that is utilized or executed by the recipient's instant messaging application or computer system to present the character, image, animation, audio, ect.

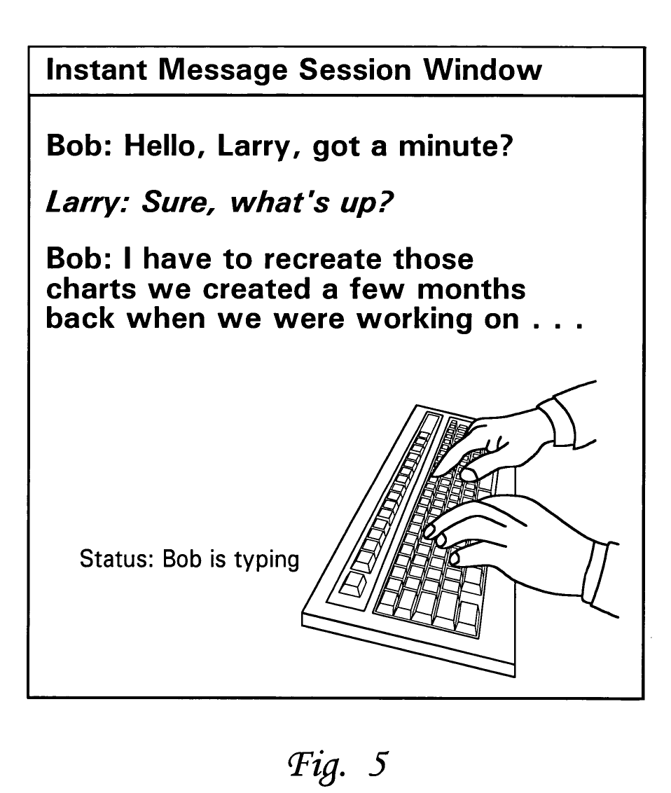

FIG. 5 shows a screenshot of the message recipient's instant messaging window during a messaging session in accordance with the preferred embodiment. The screenshot shows that the message sender (“Bob”) is currently composing a message to the message recipient (“Larry”). It can be seen that the message sender has sent a partial message, as indicated by the ellipsis. In accordance with the preferred embodiment, when the message sender exceeded the message sender's preset message length parameter, his messaging application automatically transmitted the partial message he had typed up to that point, along with an appended ellipsis to indicate that the message sender is still composing the remainder of the message to be sent to the message recipient.

Returning to FIG. 4, after transmission of the entered characters and appended ellipsis to the recipient at step 430, the process proceeds to step 435, which indicates that the sender continues to enter characters in the current message being composed. At step 440, a determination is made whether the number of characters entered by the message sender subsequent to the last transmission of a partial message at step 430 has exceeded the message length parameter. If so, the process returns to step 430, where the newly entered characters are appended with an ellipsis and transmitted to the message recipient. In a preferred embodiment, all previous transmissions of partial messages are concatenated and appended with the ellipsis for each transmission recurring at step 430. Thereafter, the sender continues entering characters in the message at step 435, and the process again makes a determination at step 440 whether the number of characters entered subsequent to the last transmission has exceeded the message length parameter.

If the decision at decision block 440 is that the number of characters entered since the last transmission has exceeded the message length parameter, the process proceeds to step 445 where it is determined if the sender has engaged a send or enter key indicating that the end of the message has been entered and the complete message should be transmitted. If not, the process returns to step 430 where the sender continues to compose the message. If at decision step 445 it is determined that the sender has engaged a key indicating the end of the message, the process passes to step 420, where the complete message is sent to the message recipient. Thereafter, the process ends at step 425.

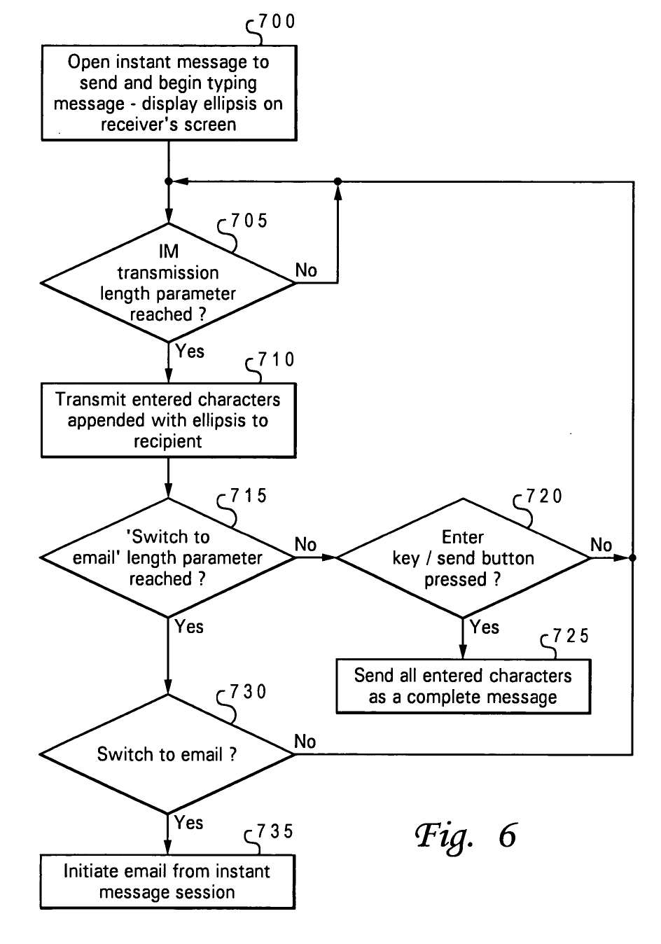

With reference now to FIG. 6, there is shown a flow diagram of another preferred embodiment of dynamic flow of messaging in a messaging session, including monitoring for the number of characters input exceeding a “switch to e-mail” (STE) text parameter length. The STE parameter is set by the user in a user preferences setting within the instant messaging application such as that shown in FIG. 3. By using the STE parameter, the user enables the instant messaging program to automatically switch to a different communications application within the computer system environment when the entered text length exceeds the STE parameter. In a preferred embodiment, when the message sender is inputting a message and the STE parameter is exceeded, the user is prompted and, at the option of the user, the text message that has been entered can then be imported into a user-defined editor or system e-mail program. At the prompt, the user can elect to enter into the e-mail application to compose the entire message and communicate using the functionality of the e-mail program.

In other embodiments, the user is prompted when the message recipient has exited the instant messaging or chat room environment. If the user was presently composing an instant message, the instant messaging application would present the user with an option to import the currently entered text in the messaging window into an alternative communication program such as e-mail.

As seen in FIG. 6, the process begins at step 700 when the user opens an instant message window and begins typing a message to a particular message recipient. At step 705, the process cycles until it is determined that the number of characters entered in the instant message since a last transmission of the instant message has exceeded the instant message (IM) transmission length parameter. Upon reaching the IM transmission length parameter, the process proceeds to step 710, where characters entered in the sender's messaging window up to that point appended with the continuation character are automatically transmitted to the message recipient for display within the message recipient's instant messaging window. The process then passes to decision 715, where it is determined if the STE length parameter has been reached. If not, a determination is made at step 720 whether the sender has indicated the end of message has been entered. If so, the process proceeds to step 725, where the entire message is sent to the message recipient. If not, the process returns to step 705 to determine if the IM transmission length parameter has been reached.

Returning to step 715, if it is determined that the STE length parameter has been reached based on the cumulative number of characters entered in the present instant message window, the process proceeds to decision block 730, where the user is presented with the option to continue composing the message within the instant messaging application or to switch to an e-mail application and import the currently typed text into the e-mail. This option is presented with a pop-up window or dialog box displayed for the user and providing a button or key that will permit the user to select the desired option. If the user elects not to switch to e-mail, the process returns to step 705 to again determine if the IM transmission length parameter has been reached since the last transmission. If the user elects to switch to e-mail, the process proceeds to step 735 where an e-mail message window is initiated, the message recipient's email address is imported from an email address book, and the text input in the instant messaging application is imported into an e-mail form. Within the e-mail application, the user can then continue to compose the message and send an email with the completed message to the message recipient.

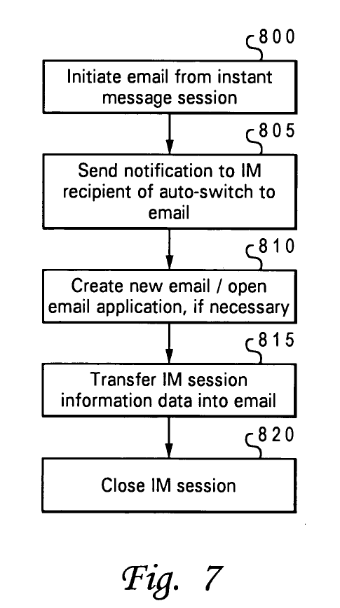

Referring now to FIG. 7, there is shown a flow diagram of a process for initiating an e-mail from an instant messaging session, in accordance with the preferred embodiment of the present invention. At step 800, the user has elected to initiate an e-mail and import entered text from an instant messaging session. At step 805, a notification is sent to the message recipient within the messaging session that the message sender has auto-switched to an e-mail application for continuing the current communication. At step 810, the e-mail application is opened, if necessary, and a new e-mail is created within the e-mail application. At step 815, the IM session information is transferred into the created e-mail. This information would include the user name of the message sender to be interpreted into an e-mail address, the user name of the message recipient, which is translated into an e-mail address in the addressee field of the e-mail, and the entered IM session text from the message currently being composed. At step 820, the current instant messaging session is closed.

While the invention has been particularly shown and described with reference to a preferred embodiment, it will be understood by those skilled in the art that various changes in form and detail may be made therein without departing from the spirit and scope of the invention.

1. A method in a data processing system for managing a messaging session, said method comprising the steps of:
receiving a plurality of characters from a message sender within the messaging session, wherein the plurality of characters forms a portion of a message within the messaging session;
determining that the number of characters of the received plurality of characters is at least equal to a preset number of characters; and
transmitting the plurality of characters to a message recipient within the messaging session.

2. The method according to claim 1, wherein the step of transmitting includes:
transmitting an indication that the transmitted plurality of characters forms only a portion of the message.

3. The method according to claim 2, wherein the indication is a predefined character appended to the plurality of characters.

4. The method according to claim 1, said method further comprising the steps of:
concatenating another plurality of characters that forms a portion of the message to the transmitted plurality of characters, thereby creating concatenated characters; and
transmitting the concatenated characters to the message recipient within the messaging session.

5. The method according to claim 4, said method further comprising the step of:
determining that the number of characters of the another plurality of characters is at least equal to a preset number of characters; and
wherein the step of concatenating is performed once it is determined that the number of characters of the another plurality of characters is at least equal to the preset number of characters.

6. The method according to claim 1, further comprising the step of determining that the end of the message is not contained within the plurality of characters.

7. The method according to claim 1, wherein the message sender defines the preset number of characters.

8. A data processing system for for managing a messaging session, said system comprising:
means for receiving a plurality of characters from a message sender within the messaging session, wherein the plurality of characters forms a portion of a message within the messaging session;
means for determining that the number of characters of the received plurality of characters is at least equal to a preset number of characters; and
means for transmitting the plurality of characters to a message recipient within the messaging session.

9. The data processing system according to claim 8, wherein the means for transmitting includes:
transmitting an indication that the transmitted plurality of characters forms only a portion of the message.

10. The data processing system according to claim 9, wherein the indication is a predefined character appended to the plurality of characters.

11. The data processing system according to claim 8, further comprising means for:
means for concatenating another plurality of characters that forms a portion of the message to the transmitted plurality of characters, thereby creating concatenated characters; and
means for transmitting the concatenated characters to the message recipient within the messaging session.

12. The data processing system according to claim 11, further comprising:
means for determining that the number of characters of the another plurality of characters is at least equal to a preset number of characters; and
wherein the step of concatenating is performed once it is determined that the number of characters of the another plurality of characters is at least equal to the preset number of characters.

13. The data processing system according to claim 8, further comprising means for determining that the end of the message is not contained within the plurality of characters.

14. The data processing system according to claim 8, wherein the message sender defines the preset number of characters.

15. An article of manufacture comprising machine-readable medium including program logic embedded therein that causes control circuitry to perform the steps of:
receiving a plurality of characters from a message sender within the messaging session, wherein the plurality of characters forms a portion of a message within the messaging session;
determining that the number of characters of the received plurality of characters is at least equal to a preset number of characters; and
transmitting the plurality of characters to a message recipient within the messaging session.

16. The article of manufacture of claim 15, wherein the step of transmitting includes:
transmitting an indication that the transmitted plurality of characters forms only a portion of the message.

17. The article of manufacture of claim 16, wherein the indication is a predefined character appended to the plurality of characters.

18. The article of manufacture of claim 15, further comprising the steps of:
concatenating another plurality of characters that forms a portion of the message to the transmitted plurality of characters, thereby creating concatenated characters; and
transmitting the concatenated characters to the message recipient within the messaging session.

19. The article of manufacture of claim 18, further comprising the step of:
determining that the number of characters of the another plurality of characters is at least equal to a preset number of characters; and
wherein the step of concatenating is performed once it is determined that the number of characters of the another plurality of characters is at least equal to the preset number of characters.

20. The article of manufacture of claim 15, further comprising the step of:
determining that the end of the message is not contained within the plurality of characters.

21. The article of manufacture of claim 15, wherein the message sender defines the preset number of characters.
